(19) United States
(12) Patent Application Publication
(10) Pub. No.: US 2012/0044428 A1
(43) Pub. Date: Feb. 23, 2012

(54) Playback Device and Associated Method

(75) Inventors: Kun-Nan Cheng, ChuPei (TW); Chieh-huang Tu, ChuPei (TW)

(73) Assignee: MSTAR SEMICONDUCTOR, INC., ChuPei (TW)

(21) Appl. No.: 13/115,344

(22) Filed: May 25, 2011

(30) Foreign Application Priority Data
Aug. 20, 2010 (TW) 099128035

(51) Int. Cl. H04N 5/44

(52) U.S. Cl. 348/734; 348/E05.096

(57) ABSTRACT

Various embodiments of a battery detector are provided. In one aspect, a playback device is capable of learning remote control signals transmitted from a source device. After learning, the playback device operates in an automatic switching mode. When a user remotely controls the source device via a remote control of the source device, the playback device automatically switches to the source device to play a source signal provided by the source device.

### CROSS-REFERENCE TO RELATED PATENT APPLICATIONS

This patent application claims priority to Taiwan, R.O.C. Patent Application No. 099128035 filed on Aug. 20, 2010, which is herein incorporated in its entirety by reference.

### BACKGROUND

1. Technical Field

The present disclosure relates to a playback device, and more particularly, to a playback device and associated method capable of performing remote control via a remote control of a source device.

2. Description of Related Art

In the modern information society, various types of data, information, news, knowledge, opinions and ideas displayed in the form of audios or/and images are carried in electronic media/multi-media data, which are played/reconstructed by a playback system via an audio-visual approach. The playback system comprises a source device and a playback device. The source device provides a multi-media data as a source signal to the playback device, and the playback device comprising a speaker and a display panel converts the source signal to audios and images.

Since modern information becomes popularized and develops prosperously, types of the source devices get diversified day by day. For example, the source device is a digital video disk (DVD) player and recorder, a blue-ray player and recorder, a modulating/demodulating modem and set-up box for receiving multi-media data via wired and/or wireless network, a multi-media player for reading multi-media data from a hard disk/flash memory/flash card, a game console, even a digital camera, a camcorder, a mobile phone and handhold device having an audio-visual output function. The playback device is an audio system, a monitor, a television (TV), a projector, and the like.

Since there are various types of source devices, an input interface of a modern playback device comprises a plurality of input ports coupled to different source devices. A user determines to switch the playback device to one input port for receiving and playing multi-media source signals provided by corresponding source devices. However, for the user, such type of manual source switch control approach is extremely inconvenient. For example, when the user wishes to play a multi-media data provided by a first source device, he needs to control the first source device to provide source signals via a remote control of the first source device. When power of the playback device is not yet turned on, the user needs to turn on the power via the remote control of the playback device. After that, the user switches the signal source of the playback device to an input port corresponding to the first source device via the remote control of the playback device, so that the playback device can receive and play the source signals provided by the first source device. When the user wishes to play a multi-media data of a second source device, the playback device only begins to play source signals provided by the second source device, provided that the user not only controls to operate the second source device via a remote control of the second source device but also switches the signal source to the second source device via the remote control of the playback device again, so that members of one family need to remember all types of input ports corresponding to the source devices to increase efficiency of operations. In other words, in an overall playback flow of the playback system, the user needs to alternately apply the remote control of the playback device and the remote controls of all source devices, and thus the playback flow becomes complicated and extremely unkind.

### SUMMARY

In order to overcome the disadvantages of the prior art, a playback device and associated method capable of automatically switching source devices is provided in the present disclosure. The playback device learns remote control signals from various source devices. For example, a remote control device of each source device has a playback button. A user presses the playback button of one remote control device of the first source device to remote control the first source device to provide a source signal carrying a multi-media data to the playback device, and presses a playback button of a remote control device of a second source device to provide a corresponding source signal. The playback device can learn remote control signals transmitted when the playback buttons of the two remote controls are pressed. After the learning, when the user presses a playback button of a certain remote control, the playback device can identify the remote control and automatically switch to a source device corresponding to the identified remote control to play the source signal provided by the source device. That is, according to the present disclosure, the user does not need to apply different remote control devices of the playback device and the source devices; when the user only uses remote control devices of the source devices, it automatically triggers switching of signal sources of the playback device and/or perform associated operations.

According to an embodiment of the present disclosure, a playback device comprises an input interface, a remote control receiving circuit, a storage module, a controller, and a playback circuit. The input interface comprises a plurality of input ports each being coupled to a corresponding source device. The remote control receiving circuit receives a remote control signal, and provides a corresponding receiving signal. The storage module records information via a non-volatile approach. The controller for controlling operations of the playback device operates in a learning mode and an automatic switching mode, and comprises a matching module and a switch module. When the controller operates in the learning mode, and the remote control receiving circuit receives a first remote control signal and provides a first receiving signal, the controller transmits the first receiving signal to the storage module and stores the first receiving signal as a learning data, and relates the learning data to one of the input ports. When the controller operates in the automatic switch mode, and the remote control receiving circuit receives a second remote control signal and provides a second receiving signal, the matching module receives the second receiving signal to match the learning data stored in the storage module with the second receiving signal. Upon determining one stored learning data matches with the second receiving signal, the matching module provides a corresponding matching result. The switch module selects one of the input ports of the input interface related to the determined stored learning data according to the matching result of the matching module to perform operations, e.g., a source signal provided by a source device coupled to one input port is received and is transmitted to the playback circuit. The playback circuit comprises at least one of a speaker and a display panel for converting the source signal received from the switch module to at least one of images or audios.

The controller relates the learning data to an operation list that records one or a plurality of commands. When the matching module provides the matching result, the controller performs at least one of the recorded commands for controlling the playback circuit according to the operation list that is related to the stored learning data. For example, when the remote control signal of the ‘playback’ button of the first remote control device of the first source device is recorded as the learning data, the user records other playback parameters of the first source device as commands in the operation list, such as preferred playback volume, luminance, contrast ratio, and the like. Likewise, when a remote control signal of the ‘playback’ button of the remote control device of the second source device is recorded as another learning data, playback parameters of the second source device are recorded as commands in the operation list. When the user presses a ‘playback’ button or a certain remote control, the playback device not only switches the signal source to the source device corresponding to the remote control via automatic switching of input ports, but also automatically performs the operation list corresponding to the source device to control the playback circuit according to the operation list, e.g., the source signal provided by the source device is played via corresponding playback parameters.

According to another embodiment of the present disclosure, a playback device comprises an input interface, a remote control receiving circuit, a storage module, and a controller, which operates in a learning mode and an automatic switch mode. When the controller operates in the learning mode, and the remote control receiving circuit receives a first remote control signal and provides a first receiving signal, the controller transmits the first receiving signal to the storage module to store the first receiving signal as a learning data, which is related to an operation list and one of a plurality of input ports. When the controller operates in the automatic switch mode, and the remote control receiving circuit receives a second remote control signal and provides a second receiving signal, the controller matches the second receiving signal with the learning data stored in the storage module. When it is determined that one stored learning data matches with the second receiving signal, the controller performs an operation list related to the determined stored learning data. For example, a command of the operation list is that the playback device scans an input port related to the determined learning data to check whether a source device of the input port provides signals.

Upon receiving a remote control signal, the remote control receiving circuit samples the remote control signal and further captures characteristics of the remote control signal to form a corresponding receiving signal.

According to yet another embodiment of the present disclosure, a method applied to a playback device comprises: in a learning mode, receiving via the playback device a first remote control signal transmitted from a remote control of a source device, storing a corresponding learning data in the playback device, and relating the learning data to the source device corresponding to the remote control; in an automatic switch mode, when the playback device receives a second remote control signal, matching the second remote control signal with the learning data stored in the playback device, and When it is determined that one stored learning data matches with the second receiving signal, receiving (and playing) a source signal provided by a source device related to the determined learning data.

According to still another embodiment of the present disclosure, a method applied to a playback device comprises: in a learning mode, receiving by the playback device a first remote control signal transmitted from a remote control of a source device, storing a corresponding learning data in the playback device, relating the learning data and an operation list to a source device corresponding to the remote control, and recording commands in the operation list; in an automatic switch mode, when the playback device receives a second remote control signal, matching the second remote control signal with the learning data, and when it is determined that one stored learning data matches with the second receiving signal, performing at least one of the commands recorded in the operation list related to the determined learning data.

The advantages and spirit related to the present disclosure can be further understood via the following detailed description and drawings.

### BRIEF DESCRIPTION OF THE DRAWINGS

FIG. 1 is a schematic diagram of a playback system in accordance with an embodiment of the present disclosure.

FIG. 2 is a flow chart of operations of a playback method in accordance with an embodiment of the present disclosure.

### DETAILED DESCRIPTION OF THE PREFERRED EMBODIMENTS

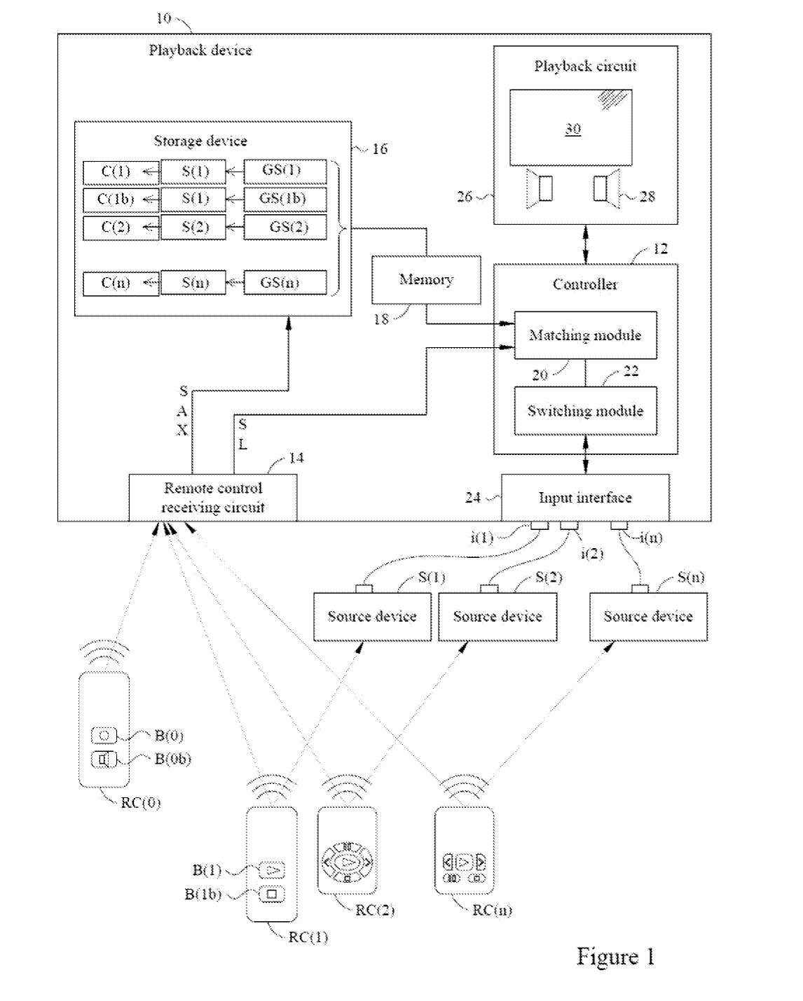

FIG. 1 shows a schematic diagram of a playback system comprising a playback device 10 and a plurality of source devices S(1) to S(n) in accordance with an embodiment of the present disclosure. The playback device 10 comprises a controller 12, a remote control receiving circuit 14, a non-volatile storage module 16, a volatile memory 18, an input interface 24, and a playback circuit 26. The controller 12 comprises a matching module 20 and a switch module 22. The storage module 16 records information via a non-volatile way, in one example, the storage module is a flash memory. The memory 18 serves as a buffer, such as a register, a dynamic random access memory (DRAM) or a static random access memory (SRAM). The information stored in the storage module 16 is loaded into the memory 18 for fast access. The input interface 24 comprises a plurality of input ports i(1) to i(n), which are respectively coupled to source devices S(1) to S(n) for providing source signals carrying multi-media data. The switch module 22 switches between the input ports i(1) to i(n), i.e., the input ports i(1) to i(n) are selected to determine one of the source devices S(1) to S(n) for providing an active source signal, which is received from the selected input port and is transmitted to the playback circuit 26 after being processed. The playback device 10 is an audio system or a TV. The playback circuit 16 comprising a display panel 30 and a speaker 28 converts the source signal received by the switch module 22 to either images or audios, or both.

With reference to FIG. 1, the playback device 10 comprises a corresponding remote control device RC(0) having a plurality of buttons such as buttons B(0) to B(0b). Different buttons correspond to different commands. When a user presses certain button, the remote control device RC(0) encodes/modulates a command corresponding to the pressed button to an infrared (or radio) remote control signal. When the remote control receiving circuit 14 of the playback device 10 receives the remote control signal transmitted from the remote control device RC(0), the remote control signal is demodulates/decoded to retrieve the corresponding command, and the controller 12 controls operations of the playback device 10 according to the command. Likewise, the source devices S(1) to S(n) respectively correspond to remote control devices RC(1) to RC(n). For example, the remote control device RC(1) of the source device S(1) has a plurality buttons, such as buttons B(1) and B(1b), and different buttons are for triggering the remote control device RC(1) to encode/modulate different commands to different remote control signals. Remote control signals transmitted from the remote control devices RC(1) to RC(n) are not only transmitted to the source devices S(1) to S(n) respectively, but also transmitted to the remote control receiving circuit 14 of the playback device 10. Upon receiving a certain remote control signal, the receiving circuit 14 also provides a corresponding receiving signal. For example, upon receiving a remote control signal, the remote control receiving circuit 14 samples the remote control signal via an appropriate sampling frequency (e.g., a sampling frequency higher than a bandwidth of the remote control signal), digitalizes (and/or encodes) a sampling result, and/or further captures characteristics of remote control signal from the sampling result to represent the corresponding receiving signal. Sampling of the remote control signal and retrieving of the characteristics are disclosed in another R.O.C. patent application No. 098129588 of the same applicant.

The controller 12 of the playback device 10 operates in a learning mode and an automatic switch mode. Under control of the user, the playback device 10 begins with the learning mode to learn (e.g., record) the remote control signals transmitted from the remote control devices RC(1) to RC(n) according to user requirements, and relates the remote control signals to operations of the playback device 10. After the learning mode, the playback device 10 operates in the automatic switch mode to perform a related operation according to a learning result of the learning mode. For example, the user controls the playback device 10 to learn (e.g., identify) a button B(1) of the remote control RC(1), and relates the button B(1) to “switching and playing the source device S(1)”. Accordingly, under the situation that the playback device 10 completes learning and operates in the automatic switch mode, once the user presses the button B(1) of the remote control RC(1), the source device S(1) performs the corresponding operation, while the playback device 10 automatically switches a signal source to the source device S(1) corresponding to the input port i(1) so as to begin playing a source signal provided by the source device S(1).

In the learning mode, the playback device 10 prompts (via images and/or audios of the playback circuit 26) the user to press a button that is to be learned of a remote control device, and prompts the user to relate the button to a corresponding input port/a source device and a corresponding playback device operation. When the user presses the button to transmit a corresponding remote control signal via the remote control device, the remote control receiving circuit 14 receives the corresponding remote control signal to provide a corresponding receiving signal SAX. The controller 12 transmits the receiving signal SAX to store it in the storage module 16 as a learning data, and relates the learning data to the source device corresponding to the button that is to be learned according to the prompt of the user. In another embodiment, the learning data is related to a corresponding operation list according to the prompt of the user. The operation list records one or a plurality of commands capable of being performed by the playback device 10. For example, in the embodiment of FIG. 1, a learning data GS(1) is related to the source device S(1) that is connected to the input port i(1) and an operation list C(1), a learning data GS(2) is related to the source device S(2) corresponding to the input port i(2) and an operation list C(2), and the learning data GS(n) is related to a source device S(n) that is connected to the input port i(n) and an operation list C(n).

In this embodiment, different buttons of a remote control device of a source device are stored (or learned) as different learning data, and are related to different operation lists. For example, the remote control signal triggered by the button B(1) of the remote control device RC(1) is recorded as the learning data GS(1), and the remote control signal triggered by the button B(1b) is recorded as a learning data GS(1b). The learning data GS(1) and the learning data GS(1b) are related to the remote control RC(1)/the input port i(1) that is connected to the source device S(1), and are respectively related to different operation lists C(1) and C(1b). For example, the button B(1) controls the source device S(1) to provide a source signal to the playback device 10, which is controlled to switch the signal source to the source device S(1) and begins playing the source signal according to a command of the operation list C(1). Alternatively, when the playback device 10 is in a power saving mode and stops playing images/audios, the playback circuit 26 of the playback device 10 is first waken up by the command. When the button B(1b) controls the source device S(1) to pause source signals, the playback circuit 26 of the playback device 10 enters a power-saving/sleep mode according to the operation list C(1b) related to the learning data GS(1b).

The operation list records types of default playback parameters. For instance, as defined by the user, the operation list related to the source device S(1) includes “playing a source signal from the source device S(1) with a first luminance, a first contrast ratio and a first volume” and the operation list related to the source device S(2) can include “playing the source signal from the source device S(2) with a second luminance, a second contrast ratio and a second volume” in addition to “switching the signal source of the playback device to the source device S(2)”. Therefore, the embodiments of the present disclosure, differences among the source devices are calibrated, such that different source signal devices operate in their corresponding operation modes defined by the user. In addition, the operation list can also include a command for scanning input ports to check whether there is a source signal at the input ports. For example, the operation list C(n) related to the source device S(n) has the command that makes the playback device 10 to switch to and scan the input port i(n) to determine whether there is a source signal at the input port i(n), i.e., it is determined whether the source device S(n) provides the source signal. When the determination result is positive, the playback device 10 plays the source signal from the source device S(n); otherwise, the playback circuit 26 of the playback device 10 enters the power-saving/sleep mode.

When the controller 12 of the playback device 10 ends the learning mode, it enters the automatic switch mode, in which a receiving signal SL is transmitted to the matching module 20 when the remote control receiving circuit 14 receives a remote control signal to provide the corresponding receiving signal SL. The matching module 20 matches the receiving signal SL with the learning data GS(1), GS(1b), GS(2) to GS(n) stored in the storage module 16. Preferably, the learning data are loaded into the memory 18 for convenience. Upon determining that one learning data matches with the receiving signal SL, the matching module 20 provides a corresponding matching result, so that the switch mode 22 selects an input port or a source device related to the determined learning data from the input ports/source devices coupled to the input interface according to the matching result, and the controller 12 performs an operation list related to the determined learning data. For example, the playback device 10 is switched to the selected input port to receive the source signal provided by the source device, and the source signal is processed and is transmitted to the playback circuit 26 for playing.

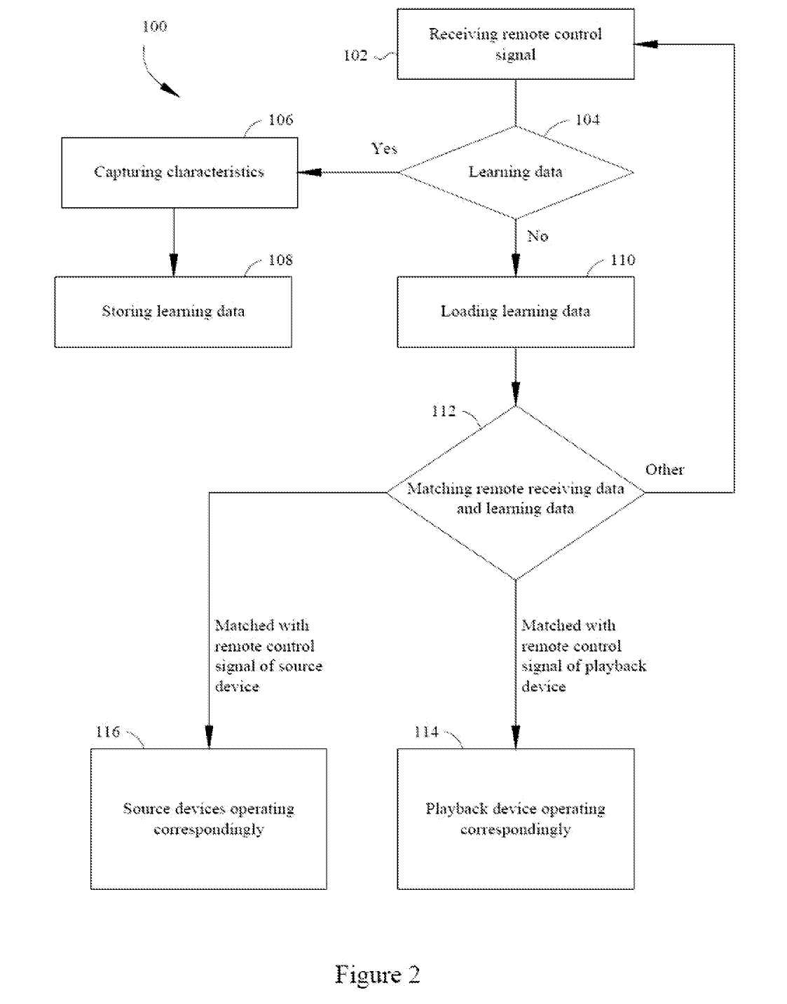

FIG. 2 is a flow chart of an operation flow 100 of a playback device 10 (in FIG. 1) in accordance with an embodiment of the present disclosure. The flow 100 comprises steps below. In Step 102, the remote control receiving circuit 14 (in FIG. 1) monitors whether any remote control signal is received. When the remote control receiving circuit 14 receives the remote control signal, subsequent steps are performed. In Step 104, if the controller 12 of the playback device 10 operates in a learning mode, the flow 100 proceeds to Step 106; if the controller 12 of the playback device 10 operates in an automatic switch mode, the flow 100 proceeds to Step 112. In Step 106, as described in the foregoing embodiment, in the learning mode, the user presses a button that is to be learned of a remote control device to trigger a remote control signal. The remote control receiving circuit 14 receives the remote control signal, and captures characteristics of the remote control signal as a receiving signal as a learning data.

When Step 106 is performed, the controller 12 of the playback device 10 performs a verification sub-procedure to verify whether the learning data correctly represents the remote control signal triggered by the to-be-learned button. For example, the controller 12 prompts via the playback circuit 26 the user to continuously press the to-be-pressed button, so as to trigger the to-be-learned remote control device to continuously and periodically transmit a plurality of identical remote control signals. During continuous iteration of the remote control signal, the remote control receiving circuit 14 first receives the plurality of remote control signals, repeats capture of the characteristics to build the learning data, and verifies whether a subsequent remote control signal or a plurality of subsequent remote control signals are matched with/verified as the identical remote control signal according to the learning data. When the matching is successful, it means that the playback device 10 can accurately identify identical remote control signals according to the learning data, so that the verification sub-procedure ends and the flow 100 proceeds to Step 108. The playback device 10 informs the user that the verification sub-procedure begins and ends via images/audios of the playback circuit 26.

Since different remote controls devices uses different modulations or encodings to carry commands into remote control signals, waveforms of various types of remote control signals are sampled and corresponding characteristics are further captured from the sampled waveforms without demodulating/decoding the remote control signals. In other words, even if the playback device 10 does not learn the modulating/encoding of the remote controls, the remote control signals transmitted from the remote controls are smoothly learned and identified.

In Step 108, the learning data built in Step 106 are stored into the non-volatile storage module 16. The learning data are related to corresponding input ports/source devices and operation lists according to the prompt of the user. The learning data are first encoded/compressed, and are then stored into the storage module 16. In Step 108, the playback device 10 learns the remote control signals transmitted from the source devices. When the flow 100 enters the automatic switch mode (starting from Step 110), operations of the playback device 10 are simplified by the user via the learning result of Step 106 to Step 108.

In Step 110, in the automatic switch mode, the learning data stored in the storage module 16 is loaded into the volatile memory 18. When the learning data of the storage module 16 has been encoded/compressed, they are loaded into the memory 18 after being decoded/decompressed. In Step 112, when the remote control receiving 14 receives any remote control signal, the receiving signal SL provided by the remote control receiving circuit 14 is transmitted to the matching module 20 for matching with the learning data. When it is determined that the remote control signal matches with the remote control signal capable of being decoded/decompressed by the playback device 10 after the receiving signal corresponding to the remote control signal matches with the learning data, it means that the remote control signal is from the remote control device RC(0) corresponding to the playback device 10, and the flow 100 proceeds to Step 114 in which the command of the remote control signal is performed by the controller.

When it is determined that the remote control signal received by the remote control signal 14 matches with a stored learning data built in the learning mode after the matching, it means that the remote control signal is from the remote control devices RC(1) to RC(n) corresponding to the source devices S(1) to S(n), and the flow 100 proceeds to Step 116.

When the remote control signal does not matches with the built learning data, and is not from the remote control device RC(0), either, the remote control signal cannot be identified, such that the flow 100 returns back to Step 102. In Step 114, the controller 12 performs the command obtained from demodulating/decoding the remote control signal. In Step 116, the controller 12 obtains the operation list related to the stored learning data, and performs the operation list.

In the embodiment of FIG. 1, the playback device 10 is an audio amplifier/equalizer. In contrast, the playback circuit 26 comprises types of driving circuits and output ends for driving external speakers coupled to the output ends. For example, the playback device 10 is a projector, and the playback circuit 16 comprises light sources, an optical projecting module and an associated server mechanism. The playback circuit 26 also comprises circuits and modules for demodulating/decoding source signals to demodulate/decode multi-media data carried by the source signals. For example, the playback circuit 26 defines corresponding demodulating/decoding circuits/modules with respect to audio-visual formats defined by motion picture experts group (MPEG) standard so as to play sources signals having MPEG formats.

Besides buttons, each of the remote control devices RC(0), RC(1) to RC(n) includes various types of interface components, such as a joystick, a wheel, a shuttle, a touch control sensor, a dynamic sensor, a position sensor, and the like, so as to sense and reflect user operations which allows remote control devices send out corresponding remote control signals. The controller 12, the memory 18, the matching module 20, the switch module 22 and/or the remote control receiving circuit 14 are integrated into one control chip. The controller 12, the matching module 20 and the switch module 22 are realized by performing software or firmware program codes via a microcontroller.

In conclusion, compared to the prior art, according to the present disclosure, a playback device learns remote control signals of source devices. When a user controls a source device via a remote control of the source device, the playback device automatically performs a related operation command, so that the user need not frequently switch a remote control of the playback device and the remote control of the source device to simplify an overall flow of audio-visual playing thereby bringing audio-visual entertainment to the user, and thus all members of a family are capable of operating a complicated audio-visual device.

While the present disclosure has been described in terms of what is presently considered to be the most practical and preferred embodiments, it is to be understood that the present disclosure needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A playback device, comprising:
an input interface comprising a plurality of input ports that can be coupled to a plurality of source devices respectively;
a remote control receiving circuit that receives a first remote control signal to provide a first receiving signal accordingly;
a storage module that records information in a non-volatile way; and
a controller, operable in a learning mode and an automatic switch mode, that transmits the first receiving signal to the storage module as a learning data and relates the learning data to one of the input ports when the controller operates in the learning mode.

2. The playback device as recited in claim 1, wherein the controller comprises:
a matching module that receives and matches a second receiving signal with the learning data stored in the storage module when the controller operates in the automatic switch mode and when the remote control receiving circuit receives a second remote control signal and provides the second receiving signal, and wherein when the matching module determines that one stored learning data matches with the second receiving signal, the matching module provides a corresponding matching result; and
a switch module that selects one of the input ports that is related to the stored learning data according to the matching result.

3. The playback device as recited in claim 2, further comprising a playback circuit that converts a source signal received by the switch module to at least one of images or audios.

4. The playback device as recited in claim 3, wherein the controller relates the learning data to an operation list that records a plurality of commands, and performs at least one of the recorded commands of the operation list that is associated with the stored learning data to control the playback circuit when the matching module provides the matching result.

5. The playback device as recited in claim 3, wherein the playback circuit comprises at least one of a display panel or a speaker.

6. The playback device as recited in claim 2, wherein each of the source devices corresponds to a respective remote control device, and wherein the first remote control signal is sent from one of the remote control devices.

7. The playback device as recited in claim 2, wherein upon receiving the first or second remote control signal, the remote control receiving circuit samples and captures characteristics of the remote control signal to respectively form the first or second receiving signal.

8. A playback device, comprising:
an input interface comprising a plurality of input ports coupled to a plurality of source devices;
a remote control receiving circuit that receives a first remote control signal to provide a first receiving signal accordingly;
a storage module that records information in a non-volatile way; and
a controller, operable in a learning mode and an automatic switch mode, that transmits the first receiving signal to the storage module as a learning data and relates the learning data to an operation list and one of the input ports when the controller operates in the learning mode, with the operation list recording a plurality of commands, when the controller operates in the automatic switch mode and when the remote control receiving circuit receives a second remote control signal to provide a second receiving signal, the controller matching the second receiving signal and the learning data stored in the storage module, and when one learning data matches with one of the stored learning data of the second receiving signal, the controller performing at least one of the commands of the operation list associated with the matching learning data.

9. The playback device as recited in claim 8, wherein when the controller performs the operation list related to the stored learning data, the controller selects one of the input ports that is related to the stored learning data to receive a source signal from a source signal device coupled to the related input port.

10. The playback device as recited in claim 8, wherein upon receiving the first or second remote control signal, the remote control receiving circuit samples and captures characteristics of the remote control signal to respectively form the first or second receiving signal.

11. The playback device as recited in claim 8, wherein when the controller performs the operation list related to the stored learning data, the controller scans the input port related to the stored learning data to check whether the source signal device coupled to the input port provides source signals.

12. A method applied to a playback device coupled to a plurality of source signal devices corresponding to a plurality of remote control devices, the method comprising:
receiving a first remote control signal transmitted from one of the remote control devices to the playback device in a learning mode;
storing a corresponding learning data in the playback device;
relating the learning data to a respective one of the source signal devices corresponding to the one of the remote control devices;
matching a second remote control signal with the learning data when the playback device receives the second remote control signal in an automatic switch mode; and
receiving a source signal from one of the source signal devices that is related to one stored learning data that matches with characteristics of the second remote control signal.

13. The method as recited in claim 12, further comprising:
relating the stored learning data to an operation list having a plurality of commands in the learning mode; and
executing by the playback device at least one of the commands in the operation list to which the stored learning data relates in the automatic switch mode.

14. The method as recited in claim 12, wherein the source signal is received and played by the playback device in the automatic switch mode.

15. The method as recited in claim 12, further comprising:
upon receiving the first remote control signal, sampling and capturing characteristics of the first remote control signal to provide a receiving signal.
